(19) United States
(12) Patent Application Publication
(10) Pub. No.: US 2025/0331502 A1
(43) Pub. Date: Oct. 30, 2025

(54) LEASH WITH CURTAIN BARRIER TO PREVENT LEASH CROSSING AND ENTANGLEMENT

(71) Applicant: Jonathan David Elkin, Fairfax, CA (US)

(72) Inventor: Jonathan David Elkin, Fairfax, CA (US)

(21) Appl. No.: 18/644,095

(22) Filed: Apr. 24, 2024

(51) Int. Cl. A01K 27/00

(52) U.S. Cl. CPC A01K 27/003; A01K 27/004

(57) ABSTRACT

A leash for pets to prevent crossing and entanglement of two or more leashes incorporates a curtain drape, web, mesh, net, fringe, or similar structure that is suspended from the leash line. The leash includes a handle, one or more leash lines, a clasp, and a suspended curtain hanging from the one or more leash lines. In one instance, the curtain extends along a portion or the entire length of the leash line. The curtain acts as a barrier or deterrent to prevent other pets from passing under the leash line, therefore, preventing crossing and entanglement when the handler is handling multiple pets simultaneously.

### BACKGROUND

The present disclosure relates to the field of animal tethers, commonly known as leashes or leads, for pets such as dogs and cats, and more specifically, to preventing entanglement between the leashes of multiple pets.

Leashes are often used by a person (“handler”) to maintain control of a pet during walks, or, by securing one end of the leash, to keep an unattended pet confined to a particular area. Walking multiple animals (herein referred to as “pets”) such as dogs simultaneously can be a challenging task, often leading to crossing, intertwining, or entanglement of the leashes because of the movement of the pets in relation to each other, or in relation to their handler. Leash entanglement not only poses a risk to the pets but also creates inconvenience and potential hazards for their handlers, such as restricted movement, tripping hazards, and potential injury. Untangling the leashes requires additional effort by the handler, and the untangling process itself presents a risk of dropping the leash and losing control of the pet. Moreover, leash entanglement may cause conflicts among pets, leading to unexpected behavior and loss of control.

### SUMMARY

The present disclosure describes a leash for pets to prevent crossing and entanglement of two or more leashes by incorporating a curtain drape, web, mesh, net, fringe, or similar structure (hereinafter referred to simply as “curtain”) that is suspended from the leash line. In one embodiment, the leash includes a handle, one or more leash lines, a clasp, and a suspended curtain hanging from the one or more leash lines. In one instance, the curtain extends along a portion or the entire length of the leash line. The curtain acts as a barrier or deterrent to prevent other pets from passing under the leash line, therefore, preventing crossing and entanglement when the handler is handling multiple pets simultaneously.

### BRIEF DESCRIPTION OF THE DRAWINGS

FIG. 1 illustrates a perspective view of an animal leash with a curtain, in accordance with one or more embodiments.

FIG. 2 illustrates a close-up view of the curtain attachment mechanism, in accordance with one or more embodiments.

FIG. 3 illustrates the adjustability of the curtain in various positions of the leash, in accordance with one or more embodiments.

FIG. 4 illustrates an example split leash with curtains hanging from each branch, in accordance with one or more embodiments.

FIG. 5 illustrates curtains that displays a pattern or uses specific materials, in accordance with one or more embodiments.

FIG. 6 is a flowchart illustrating the process of manufacturing a leash with a curtain, in accordance with one or more embodiments.

The figures depict various embodiments for purposes of illustration only.

### DETAILED DESCRIPTION

In the following description of embodiments, numerous specific details are set forth in order to provide more thorough understanding. However, note that the embodiments may be practiced without one or more of these specific details. In other instances, well-known features have not been described in detail to avoid unnecessarily complicating the description.

Embodiments are described herein with reference to the figures where like reference numbers indicate identical or functionally similar elements. Also in the figures, the leftmost digits of each reference number correspond to the figure in which the reference number is first used.

The present disclosure describes leash for a pet, comprising a leash line and a curtain hanging or suspended from the leash line. In one embodiment, the curtain extends along a portion or the entire length of the leash line. The curtain may act as a barrier or deterrent to prevent other pets from passing under the leash line to prevent entanglement when a handler(s) is handling multiple pets simultaneously.

Conventional pet leashes typically include a handle, a leash line, and a clasp to attach the leash line to a pet's collar or harness. Leashes may additionally include one or more features to prevent twisting of a single leash line attached to a single pet. For example, a swivel mechanism at an attachment point between the handle and the leash line can help prevent twisting. As another example, retractable and stretchable leashes utilize a mechanism that allows the leash line to extend and retract, eliminating slack in the leash that can lead to twisting, knotting, or crossing. Stretchable leashes offer similar benefits using a stretchable section built into the leash line. As yet another example, hands-free leashes are designed to be worn around the waist or shoulder of the handler, leaving the handler's hands free.

In addition, a handler may control two or more leash lines attached to two or more pets. For example, a split leash is designed with multiple leash lines or “branches,” allowing for simultaneous walking of multiple pets by one handler. As another example, anti-twist couplers are attachments that can be used with conventional leashes to walk multiple pets. The anti-twist couplers include rotating components that prevent the leash lines from twisting around each other.

However, all of these mechanisms do not address the situation when multiple leash lines are attached to multiple pets for the same handler or different handlers, and the pets are walked simultaneously. For example, the leashes for one handler's pets may become entangled with the other handler's pets' leashes. This situation commonly arises, for example, when two household members take their two pets for a walk, each person handling a pet. Due to limitations of the mechanisms described above, a single pet's leash still can become twisted and entangled, for example, if the pet moves around significantly during walks.

Therefore, in one embodiment, a leash is described herein including a leash line, a handle, a clasp, and a curtain hanging from the leash line. In one embodiment, the curtain extends along a portion or the entire length of the leash line. The curtain may act as a barrier or deterrent to prevent other animals from passing under the leash line to prevent entanglement when a handler(s) is handling multiple animals simultaneously.

The curtain, according to an embodiment of the present disclosure, acts as a barrier or deterrent, preventing or deterring another leashed pet (whether the other pet is being handled by the same handler or a different handler) from passing under the leash, and thus reducing the likelihood of crossing and entanglement. The curtain may also serve to deter a single pet from spinning around in place and twisting its own leash.

### Overview

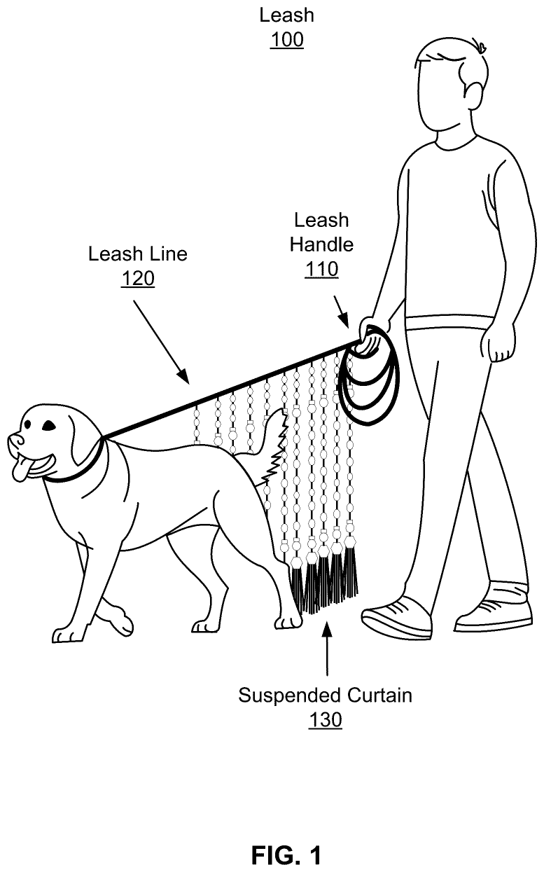

FIG. 1 illustrates a perspective view of an animal leash with a curtain, in accordance with one or more embodiments. As illustrated in FIG. 1, the leash 100 according to an embodiment includes a leash handle 110 for the handler to grasp to while, for example, walking a pet. The leash 100 also includes a leash line 120 that extends from or is connected to the handle 110. The leash line 120 is of an appropriate length to allow the pet to move freely when walking. In one embodiment, the leash 100 is retractable so that the length of the leash line 120 can be adjusted to be shorter or longer. In another embodiment, at least a portion of the leash line 120 is made from a stretchable material or a non-stretchable material. The leash 100 also includes a suspended curtain 130 that hangs down from the leash line 120.

Specifically, the curtain 130 is attached along some or all of the length of the leash line 120 and when the leash 100 is attached to a pet and the handler is handling the pet, the curtain 130 hangs down due to gravity. In one embodiment, the curtain 130 may be composed of one or a combination of a curtain drape (i.e., cloth drape), web, mesh, net, fringe, tassel, or similar structure. In one embodiment, the curtain 130 is attached to the leash line 120 by an attachment mechanism. In one instance, at least a portion of the curtain material may be removable, adjustable, or alterable so that the position, length, or density of the curtain can be adjusted to accommodate different walking scenarios, pets, handlers, terrain, or leash lengths.

The curtain 130 suspends from and hangs below the leash line 120. The curtain 130 acts as a barrier or deterrent when the leash 100 is used to handle a pet, since a second pet adjacent to this pet (e.g., a second pet on another leash walking next to the pet) is deterred from going near or passing through or under the curtain 130. In some embodiments, the curtain extends along the entire length of the leash line 120, while in others, it may be located only in certain areas where another leashed pet would otherwise be most likely to cross under.

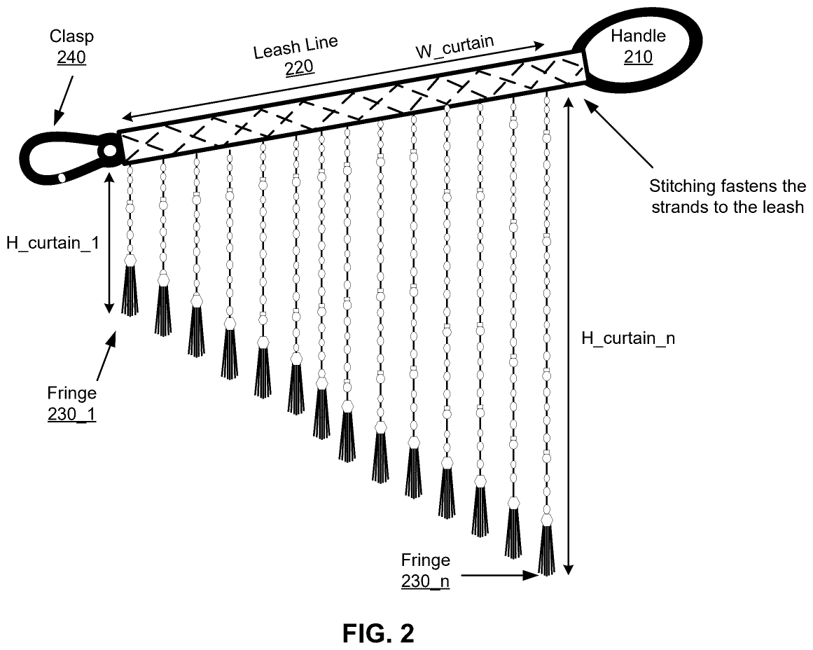

In one embodiment, as described in further detail below in conjunction with FIGS. 2 through 5, the curtain 130 may be made from a variety of materials. In one embodiment, the curtain 130 is made from durable or lightweight materials, ensuring it does not interfere with the pet's movement or the handling of the leash. It may also be constructed of materials that are suited for particular environments. The curtain 130 may be sliced vertically or otherwise similarly divided into several segments, or into many segments thus resembling a plurality of fringes, to increase its physical flexibility, reduce its weight, or enhance its appearance. In one embodiment, the curtain 130 is a retractable curtain, for example, the curtain 130 may be rolled and unrolled depending on the user of the handler.

### Detailed Structure of Leash and Curtain Attachment Mechanisms

FIG. 2 illustrates a close-up view of the curtain attachment mechanism, in accordance with one or more embodiments. The leash 200 shown in FIG. 2 includes a handle 210 (e.g., similar or identical to the handle 110), a leash line 220 (e.g., similar or identical to the leash line 120), and a curtain 230 (e.g., similar or identical to the curtain 130). As shown in FIG. 2, the curtain 230 in one embodiment includes a plurality of fringes 230_1, 230_2, . . . , 230_n. However, this is an example, and it is appreciated that in other embodiments, the curtain 230 can have any appropriate structure.

In one embodiment, the curtain 230 is attached to the leash line 220 using one or more attachment mechanisms. In one embodiment, and as illustrated in FIG. 2, the curtain 230 is attached to the leash line 220 through sewing or stitching. The reinforced attachment points ensure the durability and strength of the connection and can withstand pulling or tugging forces. In another embodiment, the curtain 230 may be attached to the leash line 220 by temporary or removable mechanisms, such as openable tubes (e.g., a zipper or hook-and-loop), closed tubes (e.g., rod pockets), or mechanisms like buttons, snaps, hooks, shackles, clasps, rings, and the like. In one embodiment, the curtain 230 and the leash line 220 may be integral to one another. As an example, the header (top) of the curtain 230 itself could serve as a portion of the leash line 220.

In addition, the curtain 230 may have a width W_curtain along the leash line 220 and one or more heights H_curtain_1, H_curtain_2, . . . , H_curtain_n that each correspond to a height of a respective strand composing the curtain 230. In one embodiment, the height of the curtain 230 may be increasingly taller as the portion is farther away from the pet, as when the handler is handling the pet, a location of the leash closer to the handler is lifted from the ground higher than a location of the leash farther away to the handler. In other embodiments, when the curtain 230 is formed from a single piece of drape or cloth, the curtain 230 may have a uniform height H_curtain. By adjusting the height or width of the curtain 230, the curtain 230 can hang closer to the ground or be lifted higher depending on the desired level of barrier or deterrent.

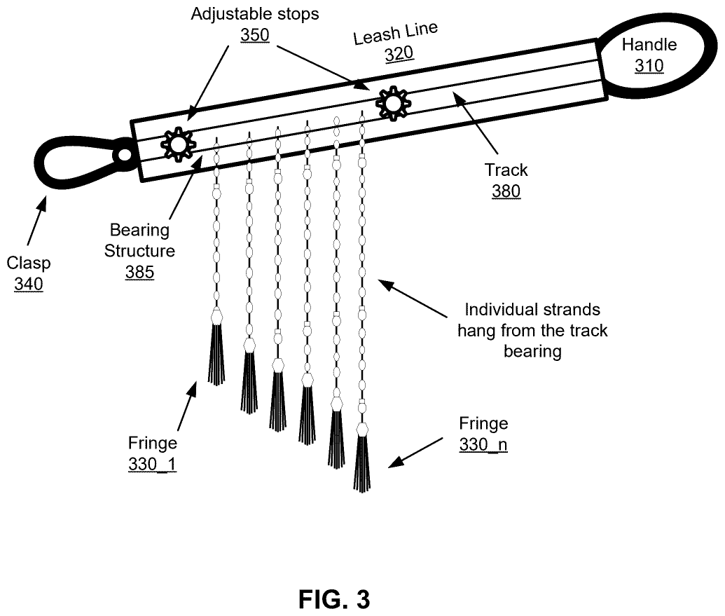

FIG. 3 illustrates the adjustability of the curtain in various positions of the leash, in accordance with one or more embodiments. The leash 300 shown in FIG. 3 includes a handle 310 (e.g., similar or identical to the handle 110), a leash line 320 (e.g., similar or identical to the leash line 120), and a curtain 330 (e.g., similar or identical to the curtain 130) including a plurality of fringes 330_1, 330_2, . . . , 330_n. In one embodiment, the curtain 330 hangs from the leash line 320 via an attachment mechanism that allows adjustability of the curtain 330 in various positions along the leash line 320. The attachment mechanism allows for customization based on different walking scenarios, pets, handlers, terrains, and leash lengths.

In one embodiment, the attachment mechanism is a track or rail mechanism embedded along the leash line 320 and one or more bearings that are attached to the curtain 330 that are configured to run along the track or rail mechanism. As shown in FIG. 3, the leash line 320 is configured with an embedded track 380. The leash 300 also includes a bearing structure 385 from which the curtain 330 is attached to. The bearing structure 385 is configured to freely move along the track 380, therefore, the handler can adjust the position of the curtain 330 at different locations on the leash line 320.

In one embodiment, the leash 300 also includes one or more adjustable stops 350 at each end of the curtain 330. Specifically, a first adjustable stop allows the handler to fix the position of a first end of the curtain 330 and a second adjustable stop allows the handler to fix the position of a second end of the curtain 330. The entire set of strands of fringes 330 for the curtain 330 can be moved closer or farther from the pet by loosening the stops 350, sliding the stops 350 and fringes along the track 380, and retightening the stops 350.

Split Leash with Curtains

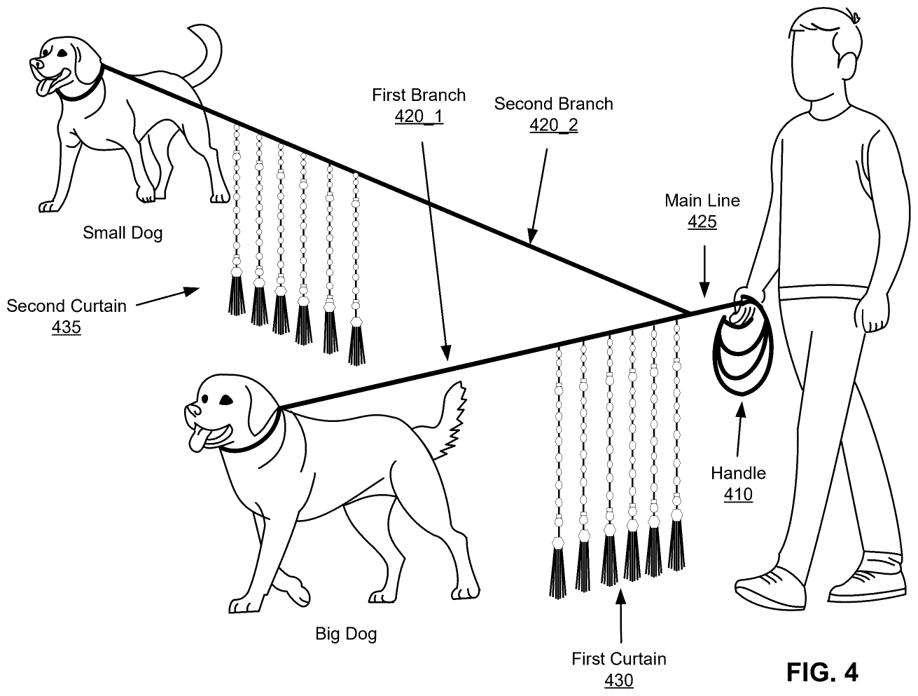

FIG. 4 illustrates an example split leash with curtains hanging from each branch, in accordance with one or more embodiments. The leash 400 shown in FIG. 4 includes a handle 410 (e.g., similar or identical to the handle 110), one or more leash lines 420_1, 420_2 (e.g., each similar or identical to the leash line 120), and one or more curtains 430, 435 (e.g., each similar or identical to the curtain 130). In one embodiment, the leash 400 is a split leash that enables the simultaneous walking of multiple dogs. In particular, the leash 400 has two or more leash lines 420_1, 420_2 or branches, each branch having its own curtain, providing separation and reducing the risk of tangling or twisting between the dogs.

Each branch has a respective curtain hanging from the branch. As an example, a first curtain 430 is suspended from the first branch 420_1, and a second curtain 435 is suspended from the second branch 420_2.

In addition, depending on the size of the pet being guided, each of the curtains 430 or 435 may have different heights or widths from each other and/or the positions of each curtain may be adjusted different from each other. For example, as the first pet is a relatively large dog, the height of the first curtain 430 may be adjusted to be relatively tall to hang closer to the ground. The first curtain 430 may also be positioned farther back from the dog. In contrast, as the second pet is a relatively smaller dog, the height of the second curtain 435 may be adjusted to be relatively short to be lifted higher from the ground. The second curtain 435 may also be positioned closer to the dog. Therefore, the average height of the first curtain 430 may be taller than the average height of the second curtain 435.

### Additional Deterrent and Illumination Mechanisms

In one embodiment, the curtain structure described herein (e.g., any of the curtains shown in FIGS. 1 through 4) is configured with additional deterrent mechanisms that prevent or deter a pet from passing under or going through the curtain. For example, these may include one or a combination of textures, sound-emitting devices, illumination or flashing lights, specific smells, taste deterrents, vibrations, physical sensations (e.g., wet or sticky), or deliver a mild electrical shock upon approach or contact. For example, one or more strands or fringes of the curtain may be made from a prickly material that is unpleasant to touch. As another example, one or more strands or fringes of the curtain may be made from Velcro that makes an annoying noise when parted. These features aim to reduce the likelihood that a pet will attempt to pass through or under the curtain.

In one embodiment, the curtain described herein may also include one or more illumination mechanisms. For example, the illumination mechanisms may include phosphorescent materials or fiber optic cables. As an example, one or more strands or fringes of the curtain may be made from glowstick-like material that is luminescent. As another example, one or more strands or fringes of the curtain may incorporate fiber optic cables as fringe strands, enabling the curtain to be chemically or electrically illuminated. By incorporating an illumination mechanism, this feature enhances visibility during low-light conditions and provides an eye-catching effect that improves safety.

### Display of Patterns on Curtain

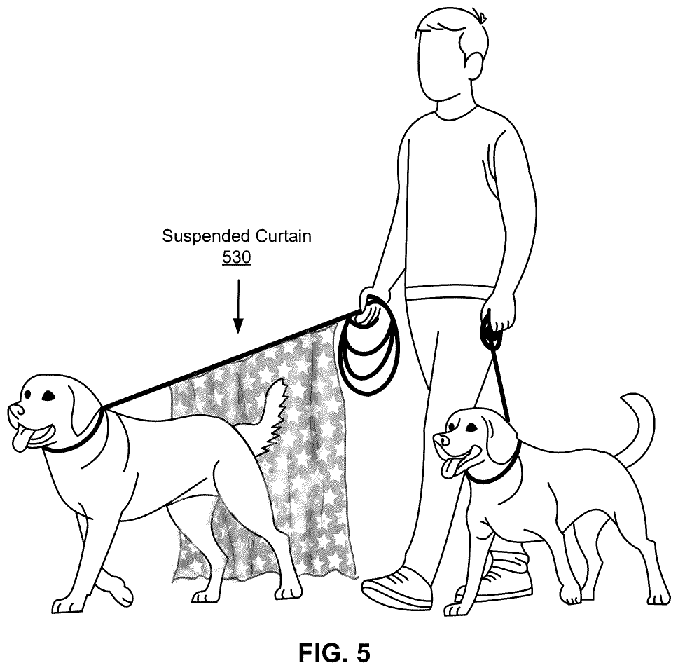

FIG. 5 illustrates a curtain that displays a pattern or uses specific materials, in accordance with one or more embodiments. As described above, the curtain structure may be designed with colors, patterns, or images, and may be made of or adorned with various materials or objects to convey a sense of style, fashion, or speech on behalf of the handler, or to enhance safety. As illustrated in FIG. 5, the curtain 530 is formed in the form of a drape with cloth material. The curtain 530 may be adorned with star-shaped patterns or other patterns according to the preference of the handler.

Moreover, it is appreciated that in other embodiments, the curtain described herein (e.g., any of the curtains described in FIGS. 1 through 5) can be used in conjunction with one or more related leashes. For example, the curtain could be used in conjunction with a leash with a swivel mechanism to further prevent knotting or twisting. It is appreciated that when a leash includes a leash line, any of the curtains described herein can be attached or suspended from the leash line, further improving the experience of the pet handler by preventing entanglement and crossing when, for example, walking multiple pets simultaneously.

By configuring the leash with the curtain structure, pet handlers can be provided with a reliable and convenient solution for avoiding leash crossing and entanglement, particularly when walking multiple pets, or when near other pet handlers. The safety, ease, and overall enjoyment of walking pets can be enhanced. Moreover, another benefit is the use of the curtain as an aesthetic mechanism (e.g., fashion or expression of speech) or to increase safety through improved visibility to others. For example, conventional leashes typically have a small projected surface area (e.g., because of rope-like structure) that is not easy to be seen by others. Another potential benefit is that the touch of the curtain against the pet can be used to proactively signal to the pet which direction the handler intends to go before the leash becomes taut, avoiding the pet being pulled or jerked by the handler. Furthermore, the sound the curtain makes when it moving, such as the natural rustling sound of the strands of a fringe-style curtain rubbing against each other, may provide a comforting or reassuring sensation to the pet, similar to white noise.

Method of Manufacturing Leash with Curtain

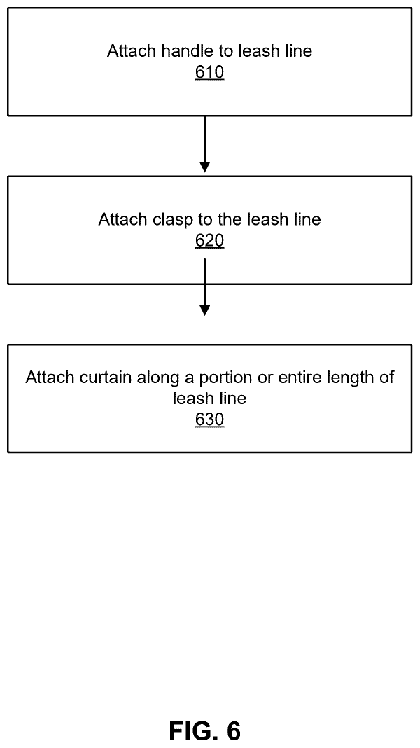

FIG. 6 is a flowchart illustrating the process of manufacturing a leash with a suspended curtain, according to one embodiment. Specifically, a leash line is attached 610 to a handle, where the handle is configured to be grasped or worn by a handler of one or more pets. A clasp is also attached 620 to one end of the leash line, where the clasp is configured to be buckled or attached to a collar or harness of a pet. A curtain is attached 630 along a portion of an entire length of the leash line. The curtain may be attached to the leash line via an attachment mechanism. The attachment mechanism may be permanent (e.g., stitches), removable (e.g., clips, hooks, buckles), and/or adjustable (e.g., rail or track embedded in the leash line). Various modifications may be made to the process described above with reference to FIG. 6.

### SUMMARY

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

1. A leash for handling a pet, comprising:
a leash line;
a curtain hanging from the leash line, wherein the curtain extends along a portion or the entire length of the leash line,
wherein the curtain acts as a barrier to deter or prevent other animals from passing under the leash line.

2. The leash of claim 1, wherein the curtain is divided into a plurality of segments or strands.

3. The leash of claim 2, wherein a height of a first strand of the curtain is taller than a second strand of the curtain, wherein the first strand is closer to a handle of the leash than the second strand.

4. The leash of claim 1, wherein the curtain and the leash line are integral to each other, and wherein a top portion of the curtain is configured as the leash line.

5. The leash of claim 1, wherein the curtain is attached to the leash line via an attachment mechanism, wherein the attachment mechanism is one or a combination of an openable tube, a closed tube, loops, buttons, snaps, hooks, shackles, clasps, rings, and stitches.

6. The leash of claim 5, wherein the leash further comprises a track embedded in the leash line configured to allow a handler to adjust a position of the curtain along the leash line.

7. The leash of claim 6, wherein the leash further comprises one or more adjustable stops on the track for a handler to adjust a position of the curtain on the leash line.

8. The leash of claim 5, wherein the curtain is removable from the leash line.

9. The leash of claim 1, wherein the curtain is configured with a deterrent mechanism, wherein the deterrent mechanism includes one or a combination of textures on the curtain, sound-emitting devices, illumination lights, smell or taste deterrents, and vibration mechanisms.

10. The leash of claim 1, wherein the curtain is configured with an illumination mechanism, wherein the illumination mechanism includes one or a combination of phosphorescent materials, reflective materials, in-built lights, luminescent materials, and optical fiber.

11. The leash of claim 10, wherein the plurality of segments include or are fiber optic cables.

12. The leash of claim 1, wherein the curtain is formed of one or a combination of cloth, web, mesh, net, fringes, and tassels.

13. The leash of claim 1, wherein the leash is a retractable leash with a retractable mechanism.

14. The leash of claim 1, wherein the leash is a split leash further comprising:
a second leash line; and
a second curtain hanging from the second leash line.

15. The leash of claim 14, wherein the split leash further comprises a swivel mechanism.

16. A method of manufacturing the leash of claim 1.

17. The leash of claim 1, wherein at least a portion of the leash line is formed from a flexible material.

18. The leash of claim 1, further comprising a clasp attached to the leash line.

19. The leash of claim 3, wherein the leash line is formed with a handle.
